(19) United States
(12) Patent Application Publication
(10) Pub. No.: US 2004/0181473 A1
(43) Pub. Date: Sep. 16, 2004

(54) Financing method for distressed real property

(76) Inventor: Ronnie E. Duke, Fenton, MI (US)

Correspondence Address: BRINKS HOFER GILSON & LIONE, P.O. BOX 10395, CHICAGO, IL, 60610, US

(21) Appl. No.: 10/386,826

(22) Filed: Mar. 12, 2003

(51) Int. Cl. G06F 17/60

(52) U.S. Cl. 705/35

(57) ABSTRACT

A method for providing financing to owners of distressed property in a stage of preforeclosure. The owner is first identified and then executes a note for an amount sufficient to remove the real property from the preforeclosure stage. That note sets forth repayment terms for a preset period of time and at an interest rate which may be either fixed or variable. After execution of the note, the face value of the note is remitted directly to the lending institution thereby removing the real property from the preforeclosure stage. Optionally, a plurality of notes are bundled together in a financial package and that financial package is then sold to a financial institution.

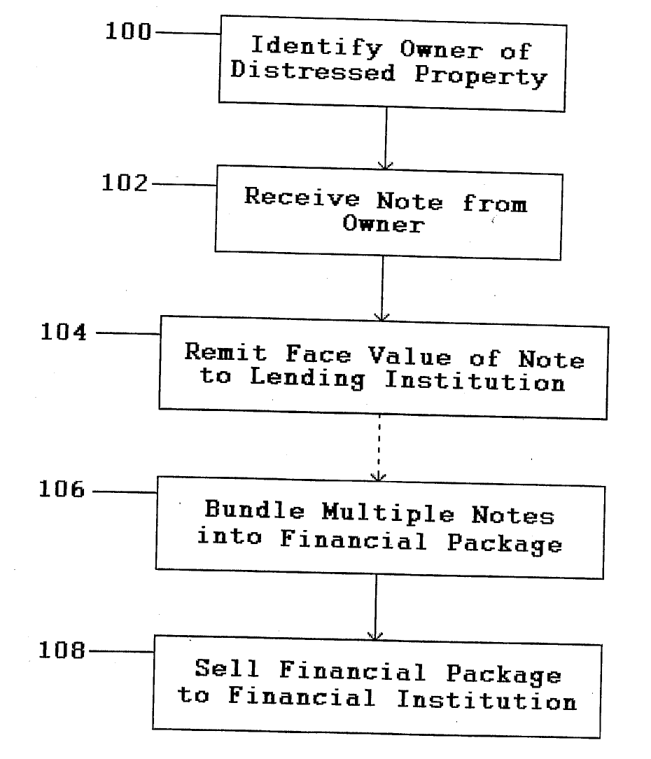

### BACKGROUND OF THE INVENTION

I. Field of the Invention

The present invention relates to a financing method for financing distressed properties.

II. Description of the Prior Art

Many persons acquire real property, such as a home, in which the owner acquires title to the property in return for granting a mortgage to a lending institution. Under the terms of the mortgage, the owner makes periodic payments to the lending institution over a period of time, typically fifteen to thirty years, and at an interest rate which may be either fixed or variable. If the owner makes all of the required payments, or pays off the mortgage in any other fashion, the lending institution discharges the mortgage whereupon the owner obtains title to the real property unencumbered by the mortgage lien.

In some situations, however, even the most financially responsible owners are temporarily unable to make the required mortgage payments. Such temporary inability may result from a temporary illness, temporary disability, temporary job loss, unexpected and necessary medical costs, or other circumstances beyond the control of the owner. These circumstances, however, are usually only temporary in nature.

Even though the inability to make the required monthly mortgage payments is only temporary in nature, the lending institution will typically initiate foreclosure proceedings against the property whenever the owner fails to timely make the mortgage payment as required by the terms of the mortgage. The time period between the initiation of the foreclosure proceedings and the actual foreclosure of the real estate property is known as the preforeclosure stage.

Whenever the foreclosure proceedings result in an actual foreclosure of the property, the property in question is sold at auction and the outstanding mortgage balance is repaid to the lending institution from the auction proceedings with any balance paid to the owner. The sale price of the real property at the auction, however, rarely realizes the full market value of the property in question. Furthermore, following the foreclosure proceedings, which may include a redemption period, the owner is ultimately evicted from the property.

The preforeclosure stage typically lasts between six and twelve months. During that time period, the temporary inability of the homeowner to timely make the mortgage payment has passed and no longer exists. However, at that time, the homeowner may be behind on the mortgage payments to the lending institution by a number of months. Although the financial condition of the homeowner may have changed so that the homeowner is able to make the required monthly mortgage payment, the financial condition of the homeowner rarely improves to such an extent that the homeowner is able to immediately pay all of the late and unpaid mortgage payments that have accrued during the preforeclosure stage. Consequently, even though the homeowner is again able to make the required monthly payments, the property nevertheless proceeds to the final foreclosure.

### SUMMARY OF THE PRESENT INVENTION

The present invention provides a method for financing property in the preforeclosure stage which prevents the final foreclosure of the real property.

In brief, owners of distressed real property are first identified. Such distressed property is in the preforeclosure stage where the owner of the property has failed to make required monthly payments to a lending institution. Typically, the owners of the real property in the preforeclosure stage have anywhere from three to six months of overdue and unpaid mortgage payments.

A lender then receives a note from the owner for an amount sufficient to remove the property from the foreclosure stage. The face value of the note is typically equal to the late and unpaid mortgage payments that are due to the lending institution plus any accrued interest and late charges assessed by the lending institution. The note also sets forth repayment terms for the note for a predetermined period of time, e.g. one to four years and preferably one to two years, and at an interest rate for the unpaid amount of the note. This interest rate may be either fixed or variable.

Following execution of the note, the lender then remits the face value of the note directly to the lending institution holding the mortgage on the property. The face value of the note is sufficient to repay the lending institution for all past due and unpaid mortgage payments, together with any assessed late fees and interest, thus removing the property from the preforeclosure stage. Thereafter, the homeowner continues to make the required monthly payments on the mortgage lien directly to the lending institution and, likewise, makes monthly payments to the lender in an amount sufficient to repay the note.

Optionally, the lender may take a security interest in the real property as collateral for the note. Once the note is repaid, the lender releases the secured interest in the property.

Additionally, after the lender has accumulated a number of notes from different homeowners of distressed property, the lender optionally bundles the notes together into a financial package. The financial package is then sold to a financial institution. After the sale of the financial package to the financial institution, the payments by the homeowners would be made directly to the financial institution, rather than to the lender.

### BRIEF DESCRIPTION OF THE DRAWING

A better understanding of the present invention will be had upon reference to the drawing, which is a diagrammatic view illustrating a preferred embodiment of the method of the present invention.

### DETAILED DESCRIPTION OF A PREFERRED EMBODIMENT OF THE PRESENT INVENTION

With reference to the drawing, at step 100 a lender identifies owners of distressed property, i.e. property in the preforeclosure stage. Any conventional means, such as advertising, may be used to locate and identify such owners of distressed properties. Typically, such owners are temporarily unable to make their required mortgage payments to the lending institution holding a mortgage because of temporary circumstances beyond the control of the homeowner.

After such owners are identified, at step 102 the owner of the distressed property executes a note to the lender in an amount sufficient to pay all overdue and unpaid mortgage payments to the lending institution, together with any costs, late fees, and interest charged by that lending institution. The note also contains repayment terms setting forth the period of repayment as well as an interest rate on the unpaid balance of the note. The time period for repayment of the note ranges from between one and four years and preferably one and two years. The interest rate may be either fixed or variable. If the interest rate is variable, it preferably is tied to a financial index, such as the prime lending rate. For example, the interest rate may be set at a fixed rate of 18% or at a variable rate of prime plus six percentage points.

Optionally, the lender also receives a security interest in the distressed property from the homeowner as a part of the note. That security interest would be subordinate to the lending institution holding the first mortgage.

After the owner executes the note at step 102, at step 104 the lender then remits the face value of the note to the lending institution thereby removing the distressed property from the preforeclosure stage. Thereafter, the owner, who has overcome the temporary disability to make the original mortgage payments, makes the monthly payments to the lending institution on the original mortgage. Similarly, the owner makes monthly payments on the note to the lender in accordance with the terms of the note until the note is repaid.

Optionally, at step 106 the lender accumulates a plurality of notes from different owners into a financial package. The lender then sells this financial package to a financial institution at step 108, preferably at a profit, and then uses the proceeds from the sale of the financial package to the financial institution to provide financing for other owners of distressed property in the preforeclosure stage.

From the foregoing, it can be seen that the present invention provides a method to provide financing to owners of distressed property in the preforeclosure stage thus enabling the owners to maintain ownership of their real property, typically their home. Furthermore, since under the method of the present invention the lender directly pays the lending institution holding the mortgage to the home, the lender ensures that the real property is removed from the preforeclosure stage and eliminates the possibility that the homeowner may spend the proceeds from the note on something other than removing the real property from the preforeclosure stage.

Having described my invention, however, many modifications thereto will become apparent to those skilled in the art to which it pertains without deviation from the spirit of the invention as defined by the scope of the appended claims.

I claim:

1. A method for providing financing for real property by a lender comprising the steps of:
identifying owners of real property that is in a stage of preforeclosure from a lending institution,
receiving a note from the owner for an amount sufficient to remove the real property from the preforeclosure stage, said note setting forth repayment terms for a predetermined period of time and at an interest rate,
remitting said amount directly to the lending institution thereby removing the real property from the preforeclosure stage.

2. The invention as defined in claim 1 and further comprising the step of receiving a security interest in the real property until the note is repaid in full by the owner.

3. The invention as defined in claim 1 wherein said predetermined period of time is in the range of one to four years.

4. The invention as defined in claim 1 wherein said predetermined period of time is in the range of one to two years.

5. The invention as defined in claim 1 wherein the interest rate is a fixed interest rate.

6. The invention as defined in claim 1 and further comprising the steps of:
accumulating a plurality of notes into a financial package,
selling the financial package to a financial institution.
